(19) United States
(12) Patent Application Publication
(10) Pub. No.: US 2025/0070315 A1
(43) Pub. Date: Feb. 27, 2025

(54) MODULAR BATTERY PACK WITH LIQUID-COOLED THERMAL PLATES

(71) Applicant: CIE Solutions LLC, Longmont, CO (US)

(72) Inventors: Stephen Ford Heston, Longmont, CO (US); Cassten Everidge, Longmont, CO (US); Justin Dunn, Longmont, CO (US); Logan Ferguson, Longmont, CO (US)

(21) Appl. No.: 18/814,733

(22) Filed: Aug. 26, 2024

Related U.S. Application Data
(60) Provisional application No. 63/578,532, filed on Aug. 24, 2023.

(51) Int. Cl. H01M 10/6568; H01M 10/48; H01M 10/613; H01M 10/643; H01M 10/6554; H01M 10/6556; H01M 50/213; H01M 50/258; H01M 50/289; H01M 50/505; H01M 50/516; H01M 50/519

(52) U.S. Cl. CPC H01M 10/6568; H01M 10/482; H01M 10/486; H01M 10/613; H01M 10/643; H01M 10/6554; H01M 10/6556; H01M 50/213; H01M 50/258; H01M 50/289; H01M 50/505; H01M 50/516; H01M 50/519

(57) ABSTRACT

The modular battery pack designs disclosed herein are intended to effectively provide for thermal management of a battery pack, while allowing for a modular design of the battery pack to achieve varied voltage, capacity, and power density requirements, and further meeting varied geometric space requirements on the battery pack. The presently disclosed designs may be particularly useful in high-energy applications (e.g., electric vehicles) with specific packaging requirements. The modular battery pack designs are capable of being scaled up or down and adapted to a variety of packaging constraints.

### CROSS-REFERENCE TO RELATED APPLICATIONS

The present application claims benefit of priority to U.S. Provisional Patent Application No. 63/578,532 entitled “MODULAR BATTERY” and filed on Aug. 24, 2023, which is specifically incorporated by reference herein for all that it discloses or teaches.

### BACKGROUND

A battery pack is an interconnected set of any number of individual battery cells (e.g., cylindrical or pouch cells) or battery sub-units that contain a subset of the overall battery cells. Battery packs may be configured in series, parallel, or a mixture thereof to deliver the desired voltage, capacity, and power density. Components of battery packs include battery cells, modules, sub-units, and interconnects that provide electrical conductivity therebetween. Generally, individual battery cells are assembled into battery modules, battery modules are assembled into battery sub-units, and battery sub-units are assembled into battery packs.

Both charging and discharging states of a battery pack generate heat. Excess heat can negatively affect battery pack longevity in the long term and battery pack capacity in the short term. Various thermal management techniques are used to manage heat of a battery pack, including but not limited to natural air convection, forced air convection, immersion cooling, liquid cooling, and/or incorporation of thermal plates, heat pipes, or other heat-transfer devices. A battery management system (BMS) is an electronic system that manages charging and charging and discharging states of the battery pack to prevent the battery from operating outside its safe operating area, monitoring its state, calculating secondary data, reporting that data, controlling its environment, authenticating it and/or balancing the battery pack.

### SUMMARY

Implementations described and claimed herein include a battery sub-unit for a modular battery pack. The battery sub-unit comprises a thermal plate with a first row of battery modules arranged in thermally conductive contact with the thermal plate's first thermally conductive surface. The thermal plate forms a structural backbone for the battery sub-unit. The thermal plate includes one or more internal coolant passages to flow coolant therethrough and conduct thermal energy from the battery modules through the thermal plate and into the coolant.

Implementations described and claimed herein include a modular battery pack comprising a series of battery sub-units. Each of the battery sub-units includes a thermal plate forming a structural backbone for the battery sub-unit, a first row of battery modules attached to the thermal plate and arranged in thermally conductive contact with a first thermally conductive surface of the thermal plate, and a second row of battery modules attached to the thermal plate and arranged in thermally conductive contact with a second thermally conductive surface of the thermal plate opposing the first thermally conductive surface of the thermal plate. Each of the battery modules includes an array of cylindrical battery cells, positive and negative terminals of each at a first axial end of each of the cylindrical battery cells, and thermal energy to conduct out of a second axial end of each of the cylindrical battery cells to the thermal plate. The thermal plate further includes one or more internal coolant passages to flow coolant therethrough and conduct thermal energy from the battery modules through the thermal plate and into the coolant.

Implementations described and claimed herein still further include a modular battery pack comprising a series of battery sub-units. Each of the battery sub-units includes a thermal plate forming a structural backbone for the battery sub-unit, a first row of battery modules attached to the thermal plate and arranged in thermally conductive contact with a first thermally conductive surface of the thermal plate, and a second row of battery modules attached to the thermal plate and arranged in thermally conductive contact with a second thermally conductive surface of the thermal plate opposing the first thermally conductive surface of the thermal plate. Each of the battery modules includes an array of cylindrical battery cells, positive and negative terminals of each at a first axial end of each of the cylindrical battery cells, and thermal energy to conduct out of a second axial end of each of the cylindrical battery cells to the thermal plate. The thermal plate further includes one or more internal coolant passages to flow coolant therethrough and conduct thermal energy from the battery modules through the thermal plate and into the coolant.

Other implementations are also described and recited herein.

### BRIEF DESCRIPTION OF THE DRAWINGS

FIG. 1 illustrates an example spiral wound cylindrical battery cell with axial thermal management and top cap contacts attached to and in thermal contact with a liquid-cooled and T-slotted thermal plate.

FIG. 2 illustrates a perspective view of a first example battery module with a set of overlying collector plates.

FIG. 3A illustrates a top view of the battery module of FIG. 2.

FIG. 3B illustrates a sectional view of the battery module of FIG. 2.

FIG. 4 illustrates a perspective view of a second example battery module with a set of overlying collector plates arranged in a split design.

FIG. 5A illustrates a top view of the battery module of FIG. 4.

FIG. 5B illustrates Section C-C of the battery module of FIG. 4.

FIG. 6 illustrates a perspective view of a third example battery module with a set of overlying embedded collector plates.

FIG. 7 illustrates a top view of the battery module of FIG. 6.

FIG. 8 illustrates a perspective view of a fourth example battery module with a set of overlying collector plates embedded on a printed circuit board.

FIG. 9 illustrates a top view of the battery module of FIG. 6.

FIG. 10 illustrates a perspective view of an example liquid-cooled thermal plate for a battery sub-unit.

FIG. 11A illustrates several views of an example liquid-cooled thermal plate and attached end cap manifold for a battery sub-unit.

FIG. 11B illustrates an exploded view of the end cap manifold of FIG. 11A.

FIG. 12 illustrates a perspective view of an example battery sub-unit.

FIG. 13 illustrates an interior perspective view of an example modular battery pack with a mounting rail and structural skin partially omitted for clarity of illustration.

FIG. 14 illustrates an exterior perspective view of an example modular battery pack.

### DETAILED DESCRIPTION

The modular battery pack designs disclosed herein are intended to effectively provide for thermal management of a battery pack while allowing for a modular design to achieve varied voltage, capacity, and power density requirements and further meet varied geometric space requirements on the battery pack. The presently disclosed designs may be particularly useful in high-energy applications (e.g., electric vehicles) with specific packaging requirements. The modular battery pack designs can be scaled up or down and adapted to various packaging constraints.

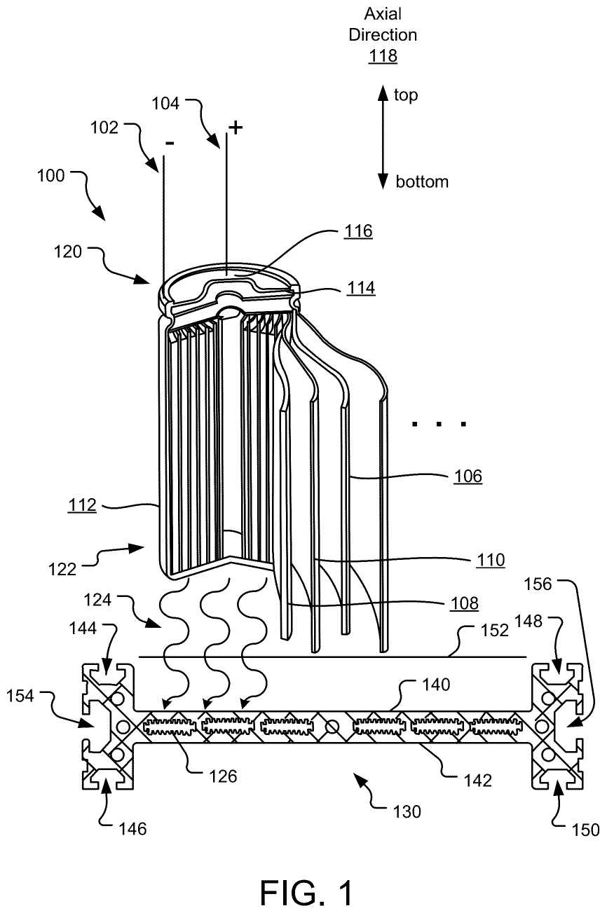

FIG. 1 illustrates an example spiral wound cylindrical battery cell 100 with axial thermal management and top cap contacts 102, 104 attached to and in thermal contact with a liquid-cooled and T-slotted thermal plate 130. In the quest for higher current carrying capacity, the active surface area of electrodes (e.g., anode 106 and cathode 108) is maximized; however, the cell case size limits the size of the electrodes that can be accommodated. One way of increasing the electrode surface area is to make the electrodes and the separators (e.g., separator 110) from long strips of foil and roll them into a spiral or cylindrical jelly-roll shape, as depicted in FIG. 1. This generally provides very low internal resistance cells. While FIG. 1 illustrates a lithium-ion (Li-ion) cell, the presently disclosed technology may also be used for nickel-cadmium (NiCad), nickel-metal-hydride (NiMH), and even some lead acid cells.

In addition to being sensitive to temperatures above and below an optimum range for operation of the battery cell 100, temperature gradients within the battery cell 100 may negatively affect its function and/or longevity. As a result, numerous prior art implementations adopt thermal management schemes intended to conduct thermal energy away from battery cells. However, these prior art solutions typically focus on conducting thermal energy in radial directions transverse to the depicted axial direction 118 of the battery cell 100. This is typically due to axial ends 120, 122 of the battery cell 100 being occupied by positive and negative terminals, respectively, which limits accessibility for conducting thermal energy in the axial direction 118. However, due to the layered construction of the battery cell 100, conduction of thermal energy in the transverse directions is generally inefficient. Stated differently, there is generally much greater significant thermal resistance in transverse directions as compared to the axial direction 118.

In the disclosed design, the battery cell 100 adopts a negative terminal (or contact) 102 and a positive terminal (or contact) 104, both at the top axial end 120 of the battery cell 100. Specifically, the negative contact 102 is connected to a top rim of a steel can 112 of the battery cell 100, while the positive contact 104 is connected to a center portion of top cap 116. The center portion of the top cap 16 is separated from the top rim of the steel can 112 by a gasket 114. Co-locating the contacts 102, 104 at the top axial end 120 leaves the bottom axial end 122 available to interface with a thermal management structure, such as liquid-cooled and T-slotted thermal plate 130.

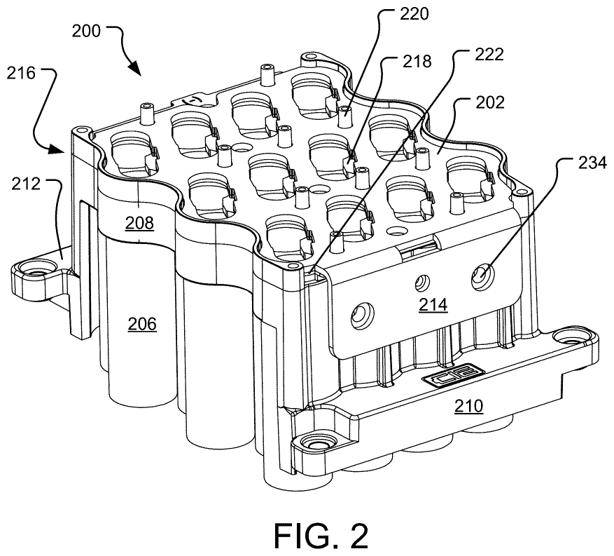

The battery cell 100, along with others within one or more nested arrays of similar battery cells arranged in battery modules (not shown, see, e.g., battery module 200 of FIG. 2), are placed with their bottom axial ends in thermally conductive contact with one of two thermally conductive sides 140, 142 of the thermal plate 130, which is shown in cross-section in FIG. 1. In various implementations, a thermal interface layer 152 (e.g., a thermal paste, adhesive, conductive pad, etc.) may be placed between the bottom axial ends of the battery cells and one of the thermally conductive sides 140, 142 to facilitate thermal transfer between the battery cells and the thermal plate 130. This allows for a majority of thermal energy to be conducted away from the battery cell 100, out of the bottom axial end 122, and into the thermal plate 130, as illustrated by wavy lines 124.

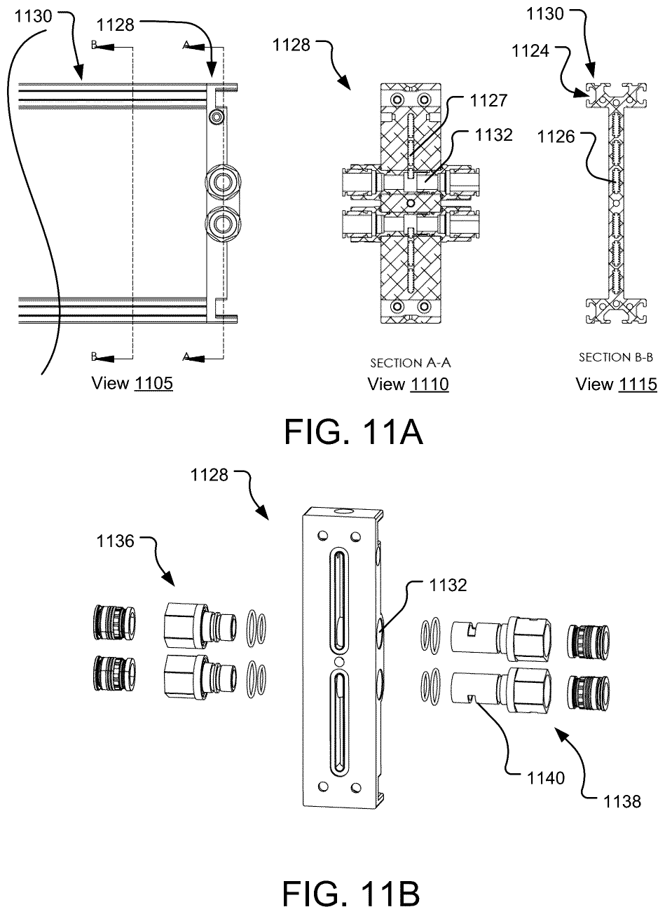

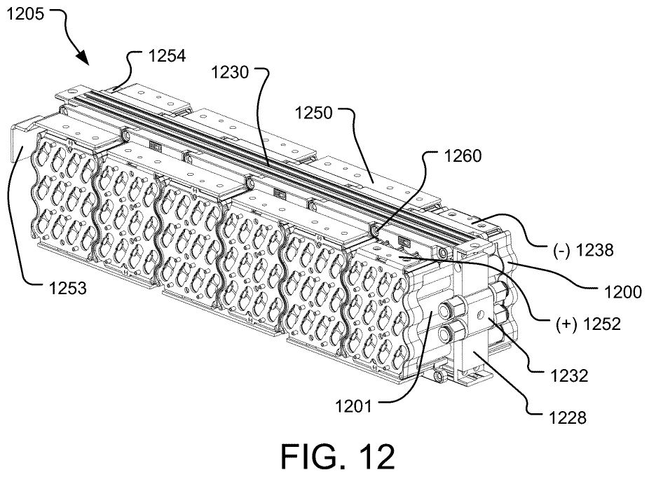

The thermal plate 130 serves as a structural backbone for a battery sub-unit (not shown, see, e.g., battery sub-unit 1205 of FIG. 12) and a cooling and/or heating plate for each connected battery module and associated battery cell. The thermal plate 130 may be made of any length, width, and height to accommodate a desired quantity of battery modules of a particular length, width, and height. Functioning as a structural backbone, the thermal plate 130 is I-shaped in cross-section (see also Section B-B of thermal plate 1130 of FIG. 11A) with four battery module mounting channels 144, 146, 148, 150, two on each side, all running lengthwise the thermal plate 130. T-slot connectors for the battery modules (or the battery modules themselves) can then be slid in place along the battery pack mounting channels on each side of the thermal plate 130 so that the battery modules can be stacked against one another in a row as illustrated in FIG. 12. This arrangement allows the thermal plate 130 to be easily adapted to any length necessary to accommodate all the battery modules necessary to achieve the overall power supply requirements of a modular battery pack.

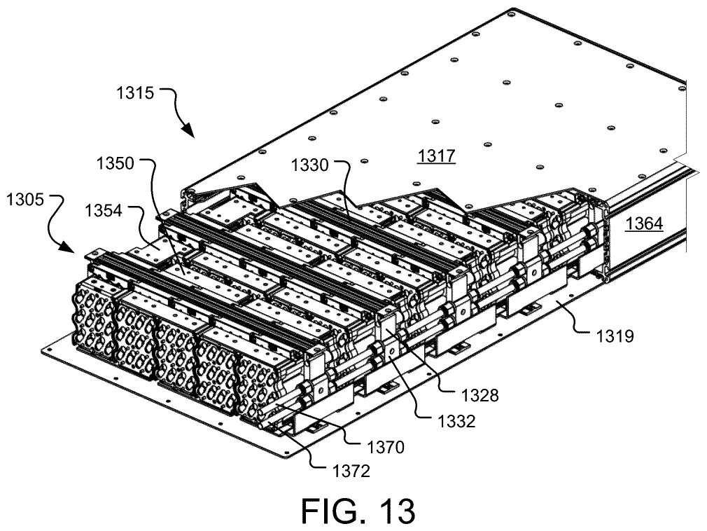

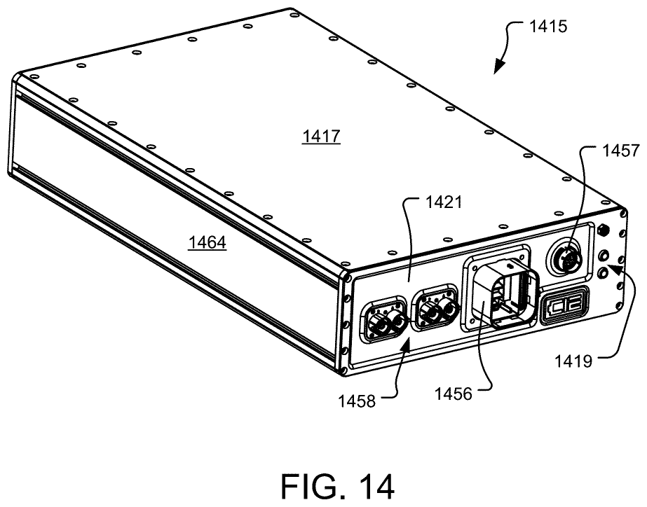

In other implementations, only a pair of battery pack mounting channels are included on only one side of the thermal plate 130, thereby accommodating only one row of battery modules on one of the thermally conductive sides 140, 142 of the thermal plate 130. Alternatively, all four mounting channels 144, 146, 148, 150 may be included, as illustrated, but only two channels adjacent to one of the thermally conductive sides 140, 142 are in use. Such implementations may be used where dimensional design specifications of the modular battery pack or one or more battery sub-units therein will not need to accommodate two rows of battery modules on opposing sides of the thermal plate 130, as illustrated in FIG. 12. The thermal plate 130 may further adopt a pair of end mounting channels 154, 156 used to attach structural panels (see, e.g., structural panels 1317, 1319 of FIG. 13) to the thermal plate 130, and other thermal plates making up a modular battery pack (see, e.g., modular battery pack 1415 of FIG. 14).

The thermal plate 130 includes six coolant passages (e.g., coolant passage 126) that permit coolant to flow through the thermal plate 130 to cool (or heat) connected battery modules, each of which is placed in thermally conductive contact with the thermal plate 130 on either or both thermally conductive sides 140, 142 of the thermal plate 130. The six coolant passages each may include an inner surface finishing, as illustrated, to increase surface area for the coolant to be in contact with as it flows through each of the coolant passages. Other implementations may omit this surface finishing or adopt a different overall shape to the coolant passages to increase surface area. Further implementations may also include greater or fewer coolant passages than that depicted in FIG. 1.

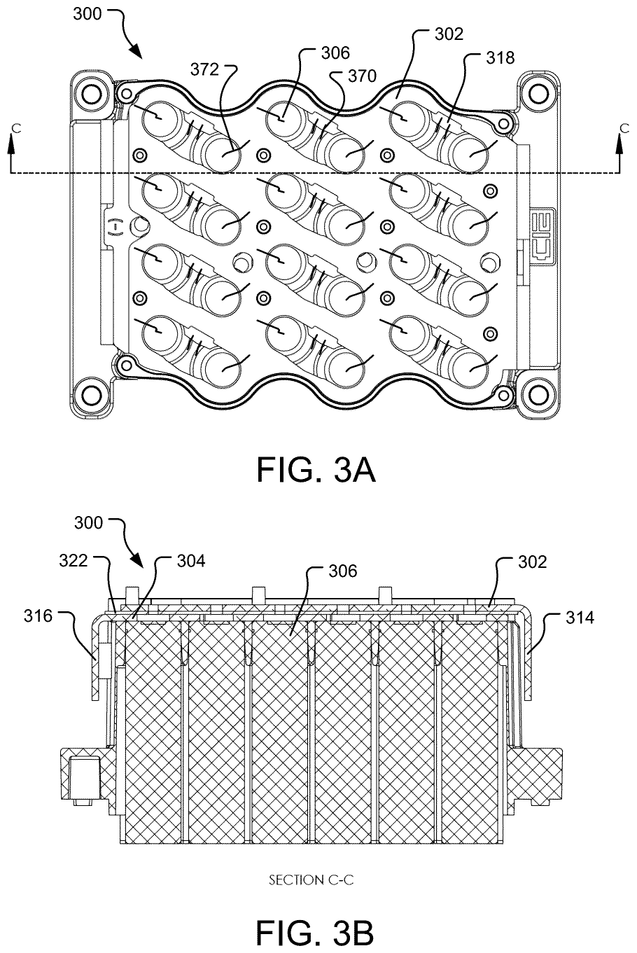

FIG. 2 illustrates a perspective view of an example battery module 200 with a set of collector plates (e.g., collector plate 202). An opposing collector plate is not visible in FIG. 2 (see e.g., collector plate 304 of FIG. 3B). The battery module 200 includes a cell housing 208, which has an array of press-fit bores, each of which is filled with a battery cell (e.g., battery cell 206). In addition to being press-fit, the battery cells may be adhered to the press-fit bores to ensure they remain in place. The array of press fit bores is arranged to maximize the number of battery cells within the cell housing 208 and arrange the battery cells in the depicted nested parallel array. The positive and negative terminals of each of the battery cells are located on one side (the depicted top side) of the nested parallel array so that the collector plates are in close proximity to both the positive and negative terminals of the battery cells. In some cases, the cell housing 208 further prevents the battery cells from contacting one another, though this may not be required. The cell housing 208 further includes a pair of mounting flanges 210, 212 that may be used to secure the battery module 200 within a modular battery sub-unit (not shown, see e.g., modular battery sub-unit 1205 of FIG. 12).

The collector plates are stacked on top of the cell housing 208, overlying the battery cells, and electrically isolated from one another by an isolator 222 oriented therebetween. The collector plate 202 is connected to a positive or negative terminal of each of the battery cells (a first subset of the terminals), while the opposing collector plate is connected to the other positive or negative terminal of each of the battery cells (a second subset of the terminals). For example, the opposing collector plate may be in compressive contact with the top rim of the steel can of each of the battery cells (see tabs, such as tab 218), thereby connecting the negative terminals of each of the battery cells to the opposing collector plate. In place of or to supplement this connection, a wire bond (not shown, see, e.g., wire bond 370 of FIG. 3A) between the battery cells and the opposing collector plate may also be utilized. The collector plate 202 is then connected to a center portion of the top cap of each of the battery cells via a wire bond (not shown, see, e.g., wire bond 372 of FIG. 3A), thereby connecting the positive terminals of each of the battery cells to the collector plate 202. In various implementations, the battery cells may be connected in series, parallel, or a combination thereof to the collector plates to achieve a desired voltage potential between the collector plates by adopting different wire bonding configurations to the collector plates and, in some implementations, by varying the design of the collector plates. This may be achievable in a singular form factor, such as that of FIG. 2, which is advantageous over prior art designs. Additional collector plates may be included in further implementations.

The isolator 222 is oriented between the positive and the negative collector plates to electrically separate the collector plates. The isolator 222 may be made of any suitable electrically insulating material, such as a plastic or fiberglass. The collector plates may also include flanges 214, 216, respectively, on opposing sides of the battery module 200 that serve as common terminals for each of the battery cells. The collector plates include attachment points (e.g., attachment point 234, which may include a threaded insert) so that the collector plates may be linked to other collector plates within a modular battery pack. The flanges 214, 216 may be oriented perpendicular to the collector plates, as illustrated to provide access and a planar attachment surface for module bus bars (not shown, see e.g., module bus bar 1250 of FIG. 12) when assembled in a battery sub-unit (not shown, see e.g., battery sub-unit 1205 of FIG. 12). Heat stakes (e.g., heat stake 220) are used to hold the various components of the battery module 200 together once assembled.

In some implementations, the isolator 222 may be a PCB that can monitor the voltage on each of the collector plates to determine if any of the battery cells have failed or become disconnected from the collector plates. This can be monitored by a battery management system (BMS) to trigger corrective action, where necessary (e.g., flag a failing battery module for replacement). Further, the PCB may include one or more temperature sensors (e.g., thermistors) to monitor the health of the battery module 200 overall and/or the individual battery cells (e.g., by identifying hot spots that may indicate a failing battery cell). The thermistors may protrude through the cell housing 208 and extend between the battery cells to monitor temperatures of the battery cells. The battery module 200 is also rotationally symmetric, so the mounting flanges 210, 212 may be used to mount the battery module 200 to a battery sub-unit in either direction. This feature will be discussed further below with reference to FIG. 12.

FIG. 3A illustrates a top view of the battery module 200 of FIG. 2, depicted as battery module 300. FIG. 3B illustrates Section C-C of the battery module 300. The collector plates 302, 304 overlay the battery cells (e.g., battery cell 306) and are electrically isolated from one another by an isolator 322 oriented therebetween. The collector plate 302 is connected to a positive or negative terminal of each of the battery cells (a first subset of the terminals), while the collector plate 304 is connected to the other positive or negative terminal of each of the battery cells (a second subset of the terminals). For example, the collector plate 304 may be in compressive contact with the top rim of the steel can of each of the battery cells (see tabs, such as tab 318), thereby connecting the negative terminals of each of the battery cells to the collector plate 304. In place of or to supplement this connection, a wire bond (e.g., wire bond 370) between the battery cells and the collector plate 304 may also be utilized. The collector plate 302 is then connected to a center portion of the top cap of each of the battery cells via a wire bond (e.g., wire bond 372) thereby connecting the positive terminals of each of the battery cells to the collector plate 302.

The isolator 322 is oriented between the positive and the negative collector plates 302, 304 to electrically separate the collector plates 302, 304. The collector plates 302, 304 may also include flanges 314, 316, respectively, on opposing sides of the battery module 300 that serve as common terminals for each of the battery cells. The flanges 314, 316 may be continuous with but oriented perpendicular to the collector plates 302, 304, as illustrated to provide access and a planar attachment surface for module bus bars (not shown, see, e.g., module bus bar 1250 of FIG. 12) when assembled in a battery sub-unit (not shown, see, e.g., battery sub-unit 1205 of FIG. 12).

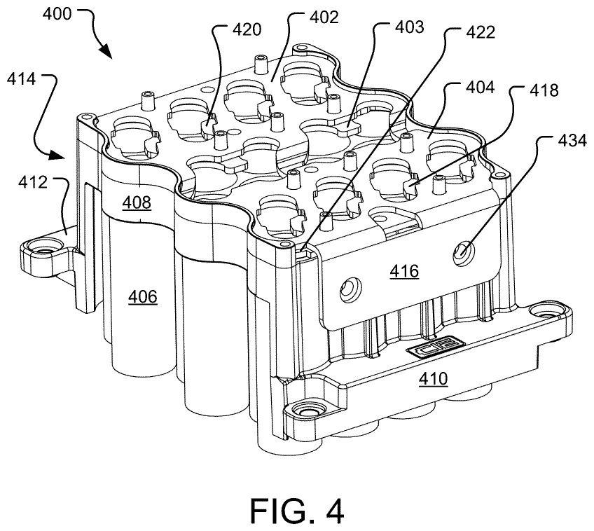

FIG. 4 illustrates a perspective view of a second example battery module 400 with a set of overlying collector plates 402, 403, 404 arranged in a split design. The battery module 400 includes a cell housing 408, which has an array of press-fit bores, each of which is filled with a battery cell (e.g., cell 406). The array of press-fit bores is arranged to maximize the number of battery cells within the cell housing 408. The positive and negative terminals of each battery cell are located on one side (the depicted top side) of the nested parallel array so that the collector plates 402, 403, 404 are close to both the positive and negative terminals of the battery cells. The cell housing 408 further includes a pair of mounting flanges 410, 412 that may be used to secure the battery module 400 within a battery sub-unit (not shown, see, e.g., battery sub-unit 1205 of FIG. 12).

Distinct from the battery module 200 of FIG. 2, the battery module 400 is a split design, allowing two subsets of the battery cells to be connected in parallel and the subsets to be connected in series, or vice versa. The collector plates 402, 403, 404 are stacked on top of the cell housing 408 and electrically isolated from one another by an isolator 422 or gap therebetween. Some implementations may adopt multiple isolators to electrically isolate the collector plates 402, 403, 404. The collector plate 402 extends across all the battery cells and is on top for half of the battery cells and on bottom for the other half of the battery cells. The collector plate 403 extends across half of the battery cells underneath the collector plate 402. The collector plate 404 extends across the other half of the battery cells on top of the collector plate 402.

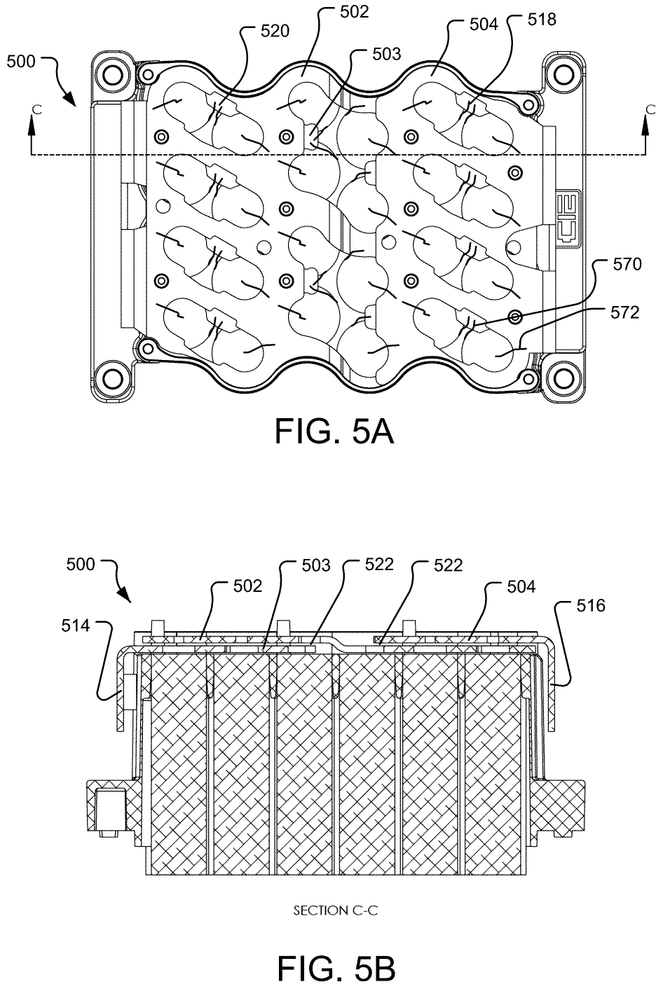

The collector plate 402 is connected to a first subset of positive or negative terminals of each of the battery cells, the collector plate 403 is connected to a second subset of the positive or negative terminals of each of the battery cells, and the collector plate 404 is connected to a third subset of the positive or negative terminals of each of the battery cells. For example, the collector plate 402 may be in compressive contact with the top rim of the steel can of some of the battery cells (see, e.g., tab 418), thereby connecting the negative terminals of some of the battery cells to the collector plate 402. Similarly, the collector plate 403 may be in compressive contact with the top rim of the steel can of others of the battery cells (see, e.g., tab 420), thereby connecting the negative terminals of some of the battery cells to the collector plate 403. In place of or to supplement these connections, a wire bond (not shown, see, e.g., wire bond 570 of FIG. 5A) between the negative terminals of the battery cells and the collector plates 402, 403, 404 may also be utilized. The collector plates 402, 403, 404 are connected to a center portion of the top cap of subsets of the battery cells via a wire bond (not shown, see, e.g., wire bond 572 of FIG. 5A), thereby connecting the positive terminals of each of the battery cells to the collector plates 402, 403, 404.

As depicted, the collector plate 402 is connected to one terminal of each of the battery cells (half being the positive terminal and the other half being the negative terminal, a first subset). The collector plate 403 is connected to the other terminal of half of the battery cells (a second subset). The collector plate 404 is connected to the other terminal of the other half of the battery cells (a third subset). The battery module 200 of FIG. 2 may connect all 24 individual battery cells in parallel, which results in a battery module 200 voltage equal to that of the individual cells. In contrast, the battery module 400 of FIG. 4 includes a first subset of 12 individual battery cells connected in parallel and a second subset of 12 individual battery cells connected in parallel. The two subsets of battery cells are connected in series, resulting in double the voltage of the battery module 200 of FIG. 2, but with the cost of half of the current capacity.

In other implementations, the battery cells may be connected in different combinations of series and/or parallel connections by adopting different wire bonding configurations to the collector plates 402, 403, 404 to achieve a desired voltage potential between the collector plates 402, 403, 404. This is achievable in a singular form factor, such as that of FIG. 4, which is advantageous over prior art designs. This flexibility allows for a more flexible battery module design, which can help achieve voltage and capacity goals in larger battery sub-units and full battery packs.

The collector plates 402, 404 include flanges 414, 416, respectively, on opposing sides of the battery module 400 that serve as common terminals for each of the battery cells. The collector plates 402, 404 include attachment points (e.g., attachment point 434, which may include a threaded insert) so that the collector plates 402, 404 may be linked to other collector plates within a modular battery pack.

FIG. 5A illustrates a top view of the battery module 400 of FIG. 4, depicted as battery module 500. FIG. 5B illustrates Section C-C of the battery module 500. The battery module 500 includes a set of collector plates 502, 503, 504 arranged in a split design. Distinct from the battery module 200 of FIG. 2, the battery module 500 is a split design, which allows for two subsets of the battery cells to be connected in parallel and the subsets to be connected in series. The collector plates 502, 503, 504 are electrically isolated from one another by isolator(s) 522 or gap oriented therebetween. The collector plate 502 extends across all the battery cells and is on top for half of the battery cells and on bottom for the other half of the battery cells. The collector plate 503 extends across half of the battery cells underneath the collector plate 502. The collector plate 504 extends across the other half of the battery cells on top of the collector plate 502.

The collector plate 502 is connected to a first subset of positive or negative terminals of each of the battery cells, the collector plate 503 is connected to a second subset of the positive or negative terminals of each of the battery cells, and the collector plate 504 is connected to a third subset of the positive or negative terminals of each of the battery cells. For example, the collector plate 502 may be in compressive contact with the top rim of the steel can of some of the battery cells (see, e.g., tab 518), thereby connecting the negative terminals of some of the battery cells to the collector plate 502. Similarly, the collector plate 503 may be in compressive contact with the top rim of the steel can of others of the battery cells (see, e.g., tab 520), thereby connecting the negative terminals of some of the battery cells to the collector plate 503. In place of or to supplement these connections, a wire bond (e.g., wire bond 570) between the negative terminals of the battery cells and the collector plates 502, 503, 504 may also be utilized. The collector plates 502, 503, 504 are connected to a center portion of the top cap of subsets of the battery cells via a wire bond (e.g., wire bond 572), thereby connecting the positive terminals of each of the battery cells to the collector plates 502, 503, 504.

In sum, the collector plate 502 is connected to one terminal of each of the battery cells (half being the positive terminal and the other half being the negative terminal, a first subset). The collector plate 503 is connected to the other terminal of half of the battery cells (a second subset). The collector plate 504 is connected to the other terminal of the other half of the battery cells (a third subset). The collector plates 502, 504 include flanges 514, 516, respectively, on opposing sides of the battery module 500 that serve as common terminals for each of the battery cells.

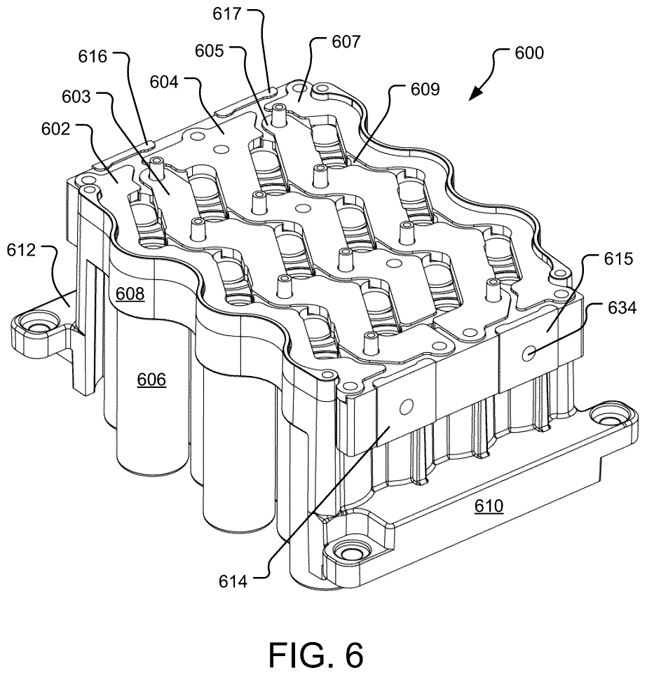

FIG. 6 illustrates a perspective view of a third example battery module 600 with a set of overlying embedded collector plates 602, 603, 604, 605, 607. The battery module 600 includes a cell housing 608, which has an array of press-fit bores, each of which is filled with a battery cell (e.g., cell 606). The array of press-fit bores is arranged to maximize the number of battery cells within the cell housing 608. The positive and negative terminals of each of the battery cells are located on one side (the depicted top side) of the nested parallel array so that the collector plates 602, 603, 604, 605, 607 are in close proximity to both the positive and negative terminals of the battery cells. The cell housing 608 further includes a pair of mounting flanges 610, 612 that may be used to secure the battery module 600 within a battery sub-unit (not shown, see e.g., battery sub-unit 1205 of FIG. 12).

Distinct from the battery module 200 of FIG. 2, the battery module 600 is an embedded design, allowing flexibility in connecting the battery cells' subgroupings in series and parallel. Specifically, the collector plates 602, 603, 604, 605, 607 are electrically distinct and embedded within the cell housing 608, which is electrically insulating. The collector plates 602, 603, 604, 605, 607 further reside within a common plane on a collector plate substrate 609 that serves as an isolator at the top of the cell housing 608.

The collector plates 602, 603, 604, 605, 607 each extend across a majority of the length of the battery module 600 so that each of the plates 602, 603, 604, 605, 607 are in close proximity to numerous battery cells. The collector plates 602, 603, 604, 605, 607 are each connected to unique non-overlapping subsets of positive or negative terminals of each of the battery cells. Each of the positive and negative terminals of each of the battery cells is connected to one of the subsets. In other implementations, there may be some overlapping between the connected positive and negative terminals of each of the battery cell subsets.

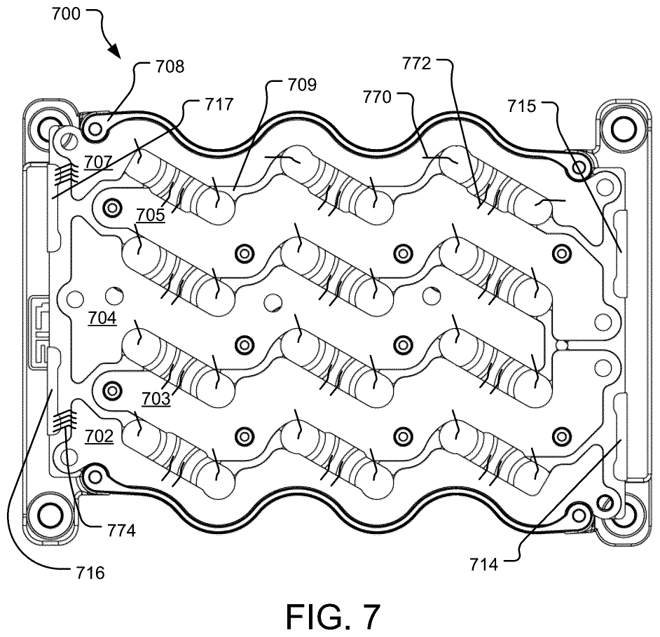

Wire bonds (not shown, see, e.g., wire bond 770 of FIG. 7) connect each of the positive terminals of each of the battery cells to one of the subsets. Wire bonds (not shown, see, e.g., wire bond 772 of FIG. 7) connect each of the negative terminals of each of the battery cells to one of the subsets as well. The cell housing 608 includes flanges 614, 615, on one side of the battery module 600 and flanges 616, 617 on the opposing side that serve as common terminals for the collector plates 602, 603, 604, 605, 607. Additional wire bonds (not shown, see e.g., wire bond 774 of FIG. 7) connect each of the collector plates 602, 603, 604, 605, 607 to one of the flanges 614, 615, 616, 617. The flanges 614, 615, 616, 617 include attachment points (e.g., attachment point 634, which may include a threaded insert) so that the flanges 614, 615, 616, 617 may be linked to other common terminals within a modular battery pack.

The battery cells may be connected in different combinations of series and/or parallel connections by adopting different wire bonding configurations to the collector plates 602, 603, 604, 605, 607 to achieve a desired voltage potential between the collector plates 602, 603, 604, 605, 607. Similarly, the collector plates 602, 603, 604, 605, 607 may be connected in different combinations of series and/or parallel connections by adopting different wire bonding configurations to the flanges 614, 615, 616, 617 to achieve a desired voltage potential between the flanges 614, 615, 616, 617, which operate as electrical terminals for the battery module 600. This is achievable in a singular form factor, such as that of FIG. 6, which is advantageous over prior art designs. This flexibility allows for a more flexible battery module design, which can help achieve voltage and capacity goals in larger battery sub-units and full battery packs.

FIG. 7 illustrates a top view of the battery module 600 of FIG. 6, depicted as battery module 700. Distinct from the battery module 200 of FIG. 2, the battery module 700 is an embedded design, allowing flexibility in connecting the battery cells' subgroupings in series and parallel. Specifically, the collector plates 702, 703, 704, 705, 707 are electrically distinct and embedded within a cell housing, which is electrically insulating. The collector plates 702, 703, 704, 705, 707 further reside within a common plane on a collector plate substrate 709 that serves as an isolator at the top of the cell housing.

Wire bonds (e.g., wire bond 770) connect each of the positive terminals of each of the battery cells to one of the collector plates 702, 703, 704, 705, 707. Wire bonds (e.g., wire bond 772) connect each of the negative terminals of each of the battery cells to one of the collector plates 702, 703, 704, 705, 707 as well. Cell housing 708 includes flanges 714, 715, on one side of the battery module 700 and flanges 716, 717 on the opposing side that serve as common terminals for the collector plates 702, 703, 704, 705, 707. Additional wire bonds (e.g., wire bond 774) connect each of the collector plates 702, 703, 704, 705, 707 to one of the flanges 714, 715, 716, 717.

In sum, the battery cells may be connected in different combinations of series and/or parallel connections by adopting different wire bonding configurations to the collector plates 702, 703, 704, 705, 707 to achieve a desired voltage potential between the collector plates 702, 703, 704, 705, 707. Similarly, the collector plates 702, 703, 704, 705, 707 may be connected in different combinations of series and/or parallel connections by adopting different wire bonding configurations to the flanges 714, 715, 716, 617 to achieve a desired voltage potential between the flanges 714, 715, 716, 717, which operate as electrical terminals for the battery module 700.

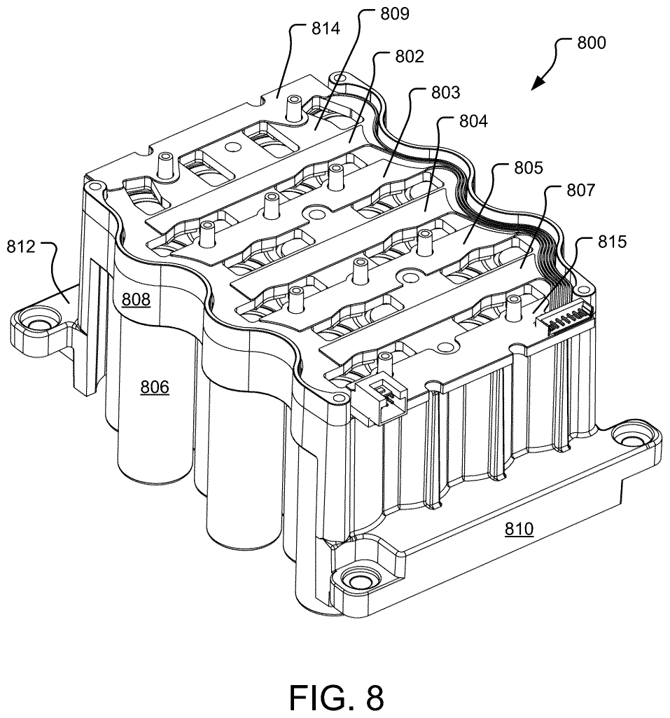

FIG. 8 illustrates a perspective view of a fourth example battery module 800 with a set of overlying collector plates 802, 803, 804, 805, 807, 814, 815 embedded on a printed circuit board (PCB) 809. The battery module 800 includes a cell housing 808, which has an array of press-fit bores, each of which is filled with a battery cell (e.g., cell 806). The array of press-fit bores is arranged to maximize the number of battery cells within the cell housing 808. The positive and negative terminals of each of the battery cells are located on one side (the depicted top side) of the nested parallel array so that the collector plates 802, 803, 804, 805, 807, 814, 815 are in close proximity to both the positive and negative terminals of the battery cells. The cell housing 808 further includes a pair of mounting flanges 810, 812 that may be used to secure the battery module 800 within a battery sub-unit (not shown, see e.g., battery sub-unit 1205 of FIG. 12).

Distinct from the battery module 200 of FIG. 2, the battery module 800 is an embedded design, allowing flexibility in connecting the battery cells' subgroupings in series and parallel. Specifically, the PCB 809 is attached to a recess in the cell housing 808, which is electrically insulating. The collector plates 802, 803, 804, 805, 807, 814, 815 take the form of large traces formed on the PCB 809, which is electrically insulating, and the collector plates 802, 803, 804, 805, 807, 814, 815 are thus electrically distinct. The collector plates 802, 803, 804, 805, 807, 814, 815 further reside within a common plane on the PCB 809 that serves as an isolator at the top of the cell housing 808.

The collector plates 802, 803, 804, 805, 807, 814, 815 each extend across a majority of the length of the battery module 800 so that each of the plates 802, 803, 804, 805, 807, 814, 815 are in close proximity to numerous battery cells. The collector plates 802, 803, 804, 805, 807, 814, 815 are each connected to unique non-overlapping subsets of positive or negative terminals of each of the battery cells. Each of the positive and negative terminals of each of the battery cells is connected to one of the subsets. In other implementations, there may be some overlapping between the connected positive and negative terminals of each of the battery cell subsets.

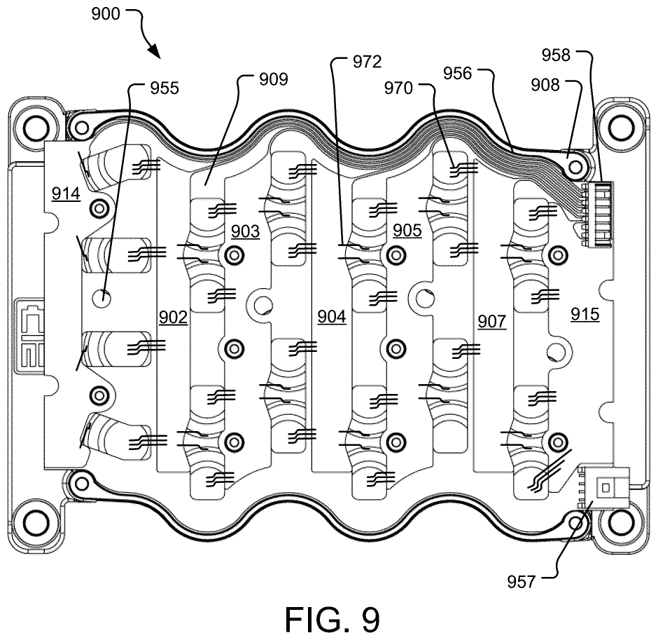

Wire bonds (not shown, see e.g., wire bond 970 of FIG. 9) connect each of the positive terminals of each of the battery cells to one of the subsets. Wire bonds (not shown, see e.g., wire bond 972 of FIG. 9) connect each of the negative terminals of each of the battery cells to one of the subsets as well. The plates 814, 815 further serve as common terminals on opposing sides of the PCB 809 that allow the battery module 800 to be electrically linked to other common terminals within a modular battery pack.

The battery cells may be connected in different combinations of series and/or parallel connections by adopting different wire bonding configurations to the collector plates 802, 803, 804, 805, 807, 814, 815 to achieve a desired voltage potential between the collector plates 802, 803, 804, 805, 807, 814, 815. This is achievable in a singular form factor, such as that of FIG. 8, which is advantageous over prior art designs. This flexibility allows for a more flexible battery module design, which can help achieve voltage and capacity goals in larger battery sub-units and full battery packs.

FIG. 9 illustrates a top view of the battery module 800 of FIG. 8, depicted as battery module 900. To form the battery module 900, the PCB 909 is attached to a recess in a cell housing 908, which is electrically insulating. Collector plates 902, 903, 904, 905, 907, 914, 915 take the form of large traces formed on the top side of the PCB 909 illustrated in FIG. 9. The bottom side of the PCB 909 lacks most of the plates 902, 903, 904, 905, 907, 914, 915, as it is placed adjacent to an array of battery cells. Collector plates 914, 915 may extend to the non-depicted bottom side of the PCB 909 if they are not placed over any battery cells.

Wire bonds (e.g., wire bond 970) connect each of the positive terminals of each of the battery cells to one of the subsets. Wire bonds (e.g., wire bond 972) connect each of the negative terminals of each of the battery cells to one of the subsets as well. The plates 914, 915 further serve as common terminals on opposing ends of the PCB 909 that allow the battery module to be electrically linked to other common terminals within a modular battery pack. The collector plates 902, 903, 904, 905, 907, 914, 915 further reside within a common plane on the PCB 909 that serves as an isolator at the top of the cell housing.

Additional traces and connectors may be implemented on the PCB 909 to provide additional functionalities. For example, the PCB 909 may include through-holes (e.g., though-hole 955) for mounting temperature sensors and wires or traces that connect the temperature sensors to a temperature connector 957 that allows for quickly connecting and disconnecting an associated connector (not shown) that leads to a battery management system (also not shown) tasked with tracking temperatures within the battery module. An unexpectedly high temperature detected by any one or more of the temperature sensors may indicate an imminent battery cell failure that could lead to combustion and additional adjacent battery cell failures.

For further example, the PCB 909 may include traces (e.g., trace 956) that connect each of the collector plates 902, 903, 904, 905, 907, 914, 915 to a voltage tap connector 958 that allows for quickly connecting and disconnecting an associated connector (not shown) that leads to a battery management system (also not shown) tasked with tracking the voltage potential of each of the collector plates 902, 903, 904, 905, 907, 914, 915. An unexpected voltage potential (high or low) at any one of the collector plates 902, 903, 904, 905, 907, 914, 915 may indicate a short or break within the battery module.

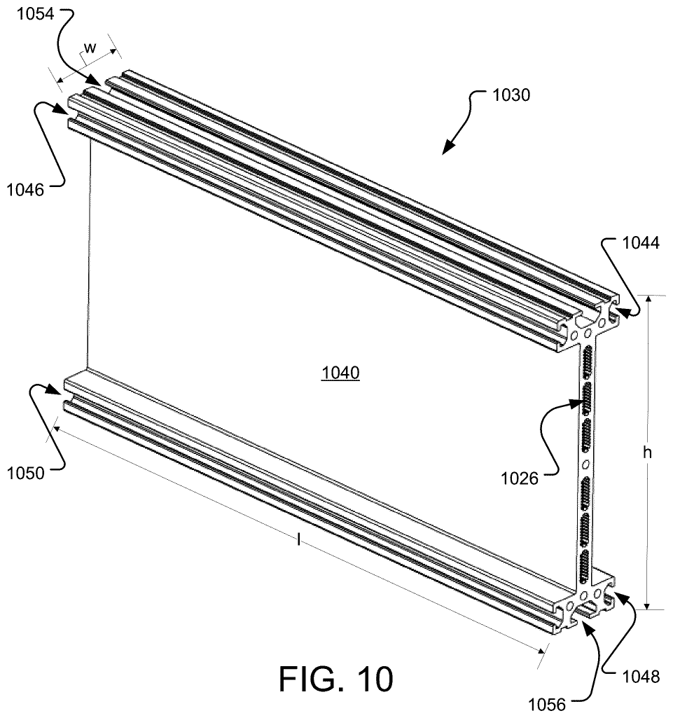

FIG. 10 illustrates a perspective view of an example liquid-cooled thermal plate 1030 for a battery sub-unit (not shown, see, e.g., battery sub-unit 1205 of FIG. 12). The thermal plate 1030 serves both as a structural backbone for the battery sub-unit, as well as a cooling and/or heating plate for each connected battery module (not shown, see, e.g., battery module 200 of FIG. 2) and associated battery cell (not shown, see e.g., battery cell 100 of FIG. 1). The thermal plate 130 may be made of any length (l), width (w), and height (h) to accommodate a desired quantity of battery modules of a particular length, width, and height themselves. The thermal plate may be a metal alloy (e.g., aluminum or steel) or any other material with sufficient structural rigidity to function as a structural backbone for the battery sub-unit and sufficient thermal conductivity to function as a thermal transfer mechanism between a set of attached battery modules and a coolant running therethrough.

Functioning as a structural backbone, the thermal plate 1030 is I-shaped in cross-section (see also Section B-B of thermal plate 1130 of FIG. 11A) with four battery module mounting channels 1044, 1046, 1048, 1050, two on each side, all running lengthwise down the thermal plate 130. T-slot connectors for the battery modules (or the battery modules themselves) can then be slid in place along the battery pack mounting channels on each side of the thermal plate 1030 so that the battery modules can be stacked against one another in a row, as illustrated in FIG. 12. This arrangement allows the thermal plate 1030 to be easily adapted to any length necessary to accommodate all the battery modules necessary to achieve the overall power supply requirements of a modular battery pack (see, e.g., modular battery pack 1415 of FIG. 14).

In other implementations, only a pair of battery pack mounting channels are included on only one side of the thermal plate 1030, thereby accommodating only one row of battery modules on one of the thermally conductive sides (e.g., thermally conductive side 1040) of the thermal plate 130. Alternatively, all four mounting channels 1044, 1046, 1048, 1050 may be included, as illustrated, but only two channels adjacent to one of the thermally conductive sides are in use. Such implementations may be used where dimensional design specifications of the modular battery pack or one or more battery sub-units therein do not accommodate two rows of battery modules on opposing sides of the thermal plate 1030, as illustrated in FIG. 12. The thermal plate 1030 may further adopt a pair of end mounting channels 1054, 1056 that attach structural panels (see, e.g., structural panels 1317, 1319 of FIG. 13) to the thermal plate 1030, and other thermal plates making up a modular battery pack.

The thermal plate 1030 includes six coolant passages (e.g., coolant passage 1026) that permit coolant to flow through the thermal plate 1030 to cool (or heat) connected battery modules, each of which is placed in thermally conductive contact with the thermal plate 1030 on either or both thermally conductive sides of the thermal plate 1030. The six coolant passages each may include an inner surface finishing, as illustrated, to increase surface area for the coolant to be in contact with as it flows through each of the coolant passages. Other implementations may omit this surface finishing or adopt a different overall shape to the coolant passages to increase surface area. Further implementations may also include greater or fewer coolant passages than that depicted in FIG. 10.

FIG. 11A illustrates several views 1105, 1110, 1115 of an example liquid-cooled thermal plate 1130 and attached end cap manifold 1128 for a battery sub-unit (not shown, see, e.g., battery sub-unit 1205 of FIG. 12). View 1105 is a partial side view of the thermal plate 1130 and the attached end cap manifold 1128. View 1110 is Section A-A of the end cap manifold 1128. View 1115 is Section B-B of the thermal plate 1130.

The thermal plate 1130 is an I-shaped rail with the end cap manifold 1128 placed on one end of the thermal plate 1130. An opposite end of the thermal plate 1130 may include a similar end cap manifold or a simpler version that connects supply coolant passages with return coolant passages and omits any valves or fittings. The thermal plate 1130 serves both as a structural backbone for a battery sub-unit (not shown, see, e.g., battery sub-unit 1205 of FIG. 12) as well as a thermal plate for each connected battery module (not shown, see, e.g., battery module 200). The thermal plate 1130 may be made of any length, width, and height to accommodate a desired quantity of battery modules of a particular length, width, and height themselves.

Functioning as a structural backbone, the thermal plate 1130 is I-shaped in cross-section (see Section B-B) with four battery module mounting channels (e.g., module pack mounting channel 1124), two on each side, all running lengthwise down the thermal plate 1130. T-slot connectors for the battery modules (or the battery modules themselves) can then be slid in place along the battery pack mounting channels on each side of the thermal plate 1130 so that the battery modules can be stacked against one another in a row, as illustrated in FIG. 12. This arrangement allows the thermal plate 1130 to be easily adapted to any length necessary to accommodate all the battery modules necessary to achieve the overall power supply requirements of the modular battery pack. In other implementations, only a pair of battery pack mounting channels are included on only one side of the thermal plate 1130, thereby accommodating only one row of battery modules on one side of the thermal plate 1130. Such an implementation may be used where a dimensional design specification of the modular battery pack will not accommodate two rows of battery modules.

The thermal plate 1130 includes six coolant passages (e.g., coolant passage 1126) that permit coolant to flow through the thermal plate 1130 to cool connected battery modules, each of which is placed in thermally conductive contact with the thermal plate 1130 on either or both sides of the thermal plate 1130. Each of the six coolant passages may include an inner surface finishing to increase the surface area with which the coolant is in contact as it flows through each of the coolant passages. Other implementations may omit this surface finishing. Further implementations may include greater or fewer coolant passages.

The end cap manifold 1128 is bolted or otherwise secured to an end of the thermal plate 1130 and forms a watertight seal against the coolant passages, which are fluidly connected to four coolant input/output ports (e.g., input/output port 1132). The input/output ports fluidly connect with coolant passages (e.g., coolant passage 1127) within the end cap manifold 1128 that, in turn, fluidly connect with the coolant passages in the thermal plate 1130.

The input/output ports connect the thermal plate 1130 to a coolant supply and return. Various coolant flow paths into, through, and out of the thermal plate 1130 are contemplated herein. For example, all ports on one end of the thermal plate 1130 could be either an input or an output, while all ports in the opposite end of the thermal plate 1130 could be the opposite. This would induce a common flow path through the thermal plate 1130 for all the coolant passages. For further example, the top three ports in the end cap manifold 1128 could be either an input or an output, while the bottom three ports in the end cap manifold 1128 could be the opposite. In a similar opposing end cap manifold placed on an opposite end of the thermal plate 1130, the top three ports and bottom three ports could be reversed from the end cap manifold 1128. This would induce two opposite flow paths through the thermal plate 1130.

For still further example, the end cap manifold 1128 is placed on one end of the thermal plate 1130, as depicted. An opposing end cap manifold placed on the opposite end of the thermal plate 1130 could lack input/output ports and merely connect the coolant passages (e.g., connect the top coolant passages to the bottom coolant passages). The top ports in the end cap manifold 1128 could be input or output ports, while the bottom ports in the end cap manifold 1128 could be the opposite. This would also induce two opposite flow paths down and back through the thermal plate 1130.

FIG. 11B illustrates an exploded view of the end cap manifold 1128 of FIG. 11A. The input/output ports are each equipped with a set of fittings (e.g., fittings 1136 that allow the input/output ports to connect to the coolant supply or return. Some of the fittings 1136 may be adjustable (e.g., adjustable fitting 1138) in that they are rotatable to change an orifice size, affecting the coolant flow rate into the corresponding input/output port. Specifically, the adjustable fitting 1138 includes orifice 1140, which, when rotated, is selectively connected to the coolant passages within the end cap manifold 1128. As such, the adjustable fittings function as adjustable valves that are integral to the end cap manifold 1128. This feature may balance flow rates through the coolant passages in the thermal plate 1130 to aid in balancing temperature across the thermal plate 1130 (and its associated connected battery modules). In systems where multiple battery sub-units are used with a common coolant supply and return, throttling the input/output using their corresponding adjustable fittings may be used to balance flow volumes through the coolant passages to aid in balancing temperature across the entire set of battery sub-units.

FIG. 12 illustrates a perspective view of an example battery sub-unit 1205. The modular battery sub-unit 1205 comprises two rows of battery modules (e.g., battery module 1201), the rows arranged on opposing sides of a thermal plate 1230. In various implementations, the battery modules may be as described above with reference to any of battery modules 200-800 of FIGS. 2-8, while the thermal plate 1230 may be as described above with reference to thermal plate 1030-1130 of FIGS. 10-11.

The battery modules within each of the two rows are nested together, as illustrated, to minimize the space required. That said, the individual battery modules may be separated by a small distance (e.g., 4 mm) to prevent conductive contact between battery cells in adjacent battery modules. Further, the individual battery modules may share overlapping fastening holes (see, e.g., overlapping fastening hole 1260) so that a single fastener may extend through overlapping holes in adjacent battery modules to help lock the battery modules together, thereby reducing the space required to mount the battery modules, and reducing fastener part count. The overlapping fastening holes may include reinforcing inserts to carry the compressive load the fasteners apply. Still further, as noted above, the battery modules may be arranged in each row to be connected in series (as generally illustrated in FIG. 12) or in parallel, or a combination thereof.

Specifically, negative terminal 1238 of the modular battery sub-unit 1205 is the negative terminal of battery module 1200. Similarly, positive terminal 1252 of the modular battery sub-unit 1205 is the positive terminal of battery module 1201. Positive and negative terminals of each battery module are connected using module bus bars (e.g., module bus bar 1250) to bolt to and electrically connect the battery modules. Bridge bus bars 1253, 1254 electrically connect two of the battery modules across the two rows when connected using an additional module bus bar (not shown). The result is all the battery modules within the battery sub-unit 1205 are electrically connected from the negative terminal 1238, down one row of the battery modules, and back up the other row of battery modules to the positive terminal 1252. Other implementations may use a different arrangement of connector plates and bus bars and/or reverse orientations of the battery modules to achieve a desired overall electrical performance from the modular battery sub-unit 1205.

The battery sub-unit 1205 is fluidly connected with other adjacent battery sub-units within a modular battery pack at input/output ports 1232 on end cap manifold 1228. The battery modules are mounted to the thermal plate 1230, with the opposing ends of each of the battery cells in thermally conductive contact with the thermal plate 1230 to conduct heat out of the battery cells, into the thermal plate 1230, and further into coolant running therethrough and out of the modular battery sub-unit 1205 at the input/output ports 1232. In some implementations, a thermal interface layer (not shown, see, e.g., thermal interface layer 152 of FIG. 1) is used between the battery cells and the thermal plate 1230 to facilitate and enhance the thermally conductive contact therebetween.

FIG. 13 illustrates an interior perspective view of an example modular battery pack 1315 with a mounting rail 1364 and structural panel 1317 partially omitted for clarity of illustration. The modular battery pack 1315 is an aligned array of modular battery sub-units (e.g., sub-unit 1305, see also modular battery sub-unit 1205 of FIG. 12). Mounting rails (e.g., mounting rail 1364) permit the battery sub-units to be arranged and secured in an aligned row and attached together. Structural panels 1317, 1319 are applied over the assembled battery sub-units, top and bottom, and screwed to T-connectors within mounting channels in the thermal plates (e.g., thermal plate 1330) of the battery sub-units to stiffen the assembly and enclose and protect the sub-units from external contamination or contact damage. End caps (not shown; see, e.g., end cap 1421 of FIG. 14) finish the enclosure of the battery sub-units within the modular battery pack 1315.

The mounting rails may be of varying lengths and heights to allow the modular battery pack 1315 to accommodate a variety number and type of battery sub-units, which may be stacked to add depth or height to the modular battery pack 1315. Positive and negative terminals of each battery module are connected using module bus bars (e.g., module bus bar 1350) to bolt to and electrically connect the battery modules to form the battery sub-units. Positive and negative terminals of each battery sub-unit are connected by way of sub-unit bus bars (e.g., bus bar 1354) that electrically connect all the battery sub-units within the modular battery pack 1315 in a manner that achieves a desired overall electrical performance from the modular battery pack 1315. In some implementations, the sub-unit bus bars are added at a final assembly step to avoid creating a dangerously high-voltage condition until just prior to attaching one or both structural panels 1317, 1319. This is technically advantageous because it allows the vast majority of assembly to occur at a lower risk to assembly personnel until just before assembly completion.

The battery sub-units are fluidly connected at their input/output ports (e.g., input/output ports 1332) on each end cap manifold (e.g., end cap manifold 1328). The modular battery pack 1315 includes battery pack input/output ports (not shown, see, e.g., battery pack input/output ports 1419 of FIG. 14) that allow the modular battery pack 1315 to connect to an external coolant supply and return. The battery sub-units are arranged in parallel and aligned, as illustrated, so that inputs to each of the series of end cap manifolds are axially aligned, and outputs from each of the series of end cap manifolds are axially aligned. This alignment allows for a set of linear tubing sections (e.g., tubing section 1370) to connect the inputs to each of the series of end cap manifolds in line and a second set of linear tubing sections (e.g., tubing section 1372) to connect the outputs to each of the series of end cap manifolds in line, as illustrated. These straight tubing runs enhance modularity as they can be extended indefinitely within a modular battery pack.

In some implementations, isolation plates are placed between battery sub-units that face one another within the modular battery pack 1315. As the venting mechanisms in case of battery cell failure are oriented within the tops of the battery cells where the terminals are located, and the bottoms of the battery cells are used for cooling, as discussed in detail above, the orientation of the battery cells within the battery sub-units that face one another also orients the venting mechanisms to face one another. The isolation plates are in place to block the venting of a failed or failing battery cell from being directed at battery cells in the facing battery sub-unit. This reduces the possibility (or slows the occurrence) of a failed or failing battery cell causing a chain reaction of further battery cell failures due to the controlled venting of gasses from the failed or failing battery cell(s).

The mounting rail 1364 may be made of extruded aluminum or other metal alloys and may serve as a chassis ground. A separate ground stud may also be incorporated into the mounting rail 1364 to connect to a separate chassis ground for an associated piece of equipment powered by the modular battery pack 1315 (e.g., an electric car). The modular nature of the battery modules that make up a battery sub-unit, and the battery sub-units that make up a modular battery pack, such as modular battery pack 1315, allows the battery modules and/or entire battery sub-units to be replaced within a modular battery pack without entirely disassembling the modular battery pack. This can allow field repair or at least easier repair at an authorized service center.

FIG. 14 illustrates an exterior perspective view of an example modular battery pack 1415. The modular battery pack 1415 is an aligned array of modular battery sub-units (not shown, see, e.g., modular battery sub-unit 1205 of FIG. 12). Mounting rails (e.g., mounting rail 1464) permit the battery sub-units to be arranged and secured in an aligned row and attached together. Structural panels (e.g., structural panel 1417) are applied over the assembled battery sub-units, top and bottom, and screwed to T-connectors within mounting channels in thermal plates of the battery sub-units to stiffen the assembly and enclose and protect the battery sub-units from external contamination or contact damage. End caps (e.g., end cap 1421) finish the enclosure of the battery sub-units within the modular battery pack 1415.

The mounting rails may be of varying lengths and heights to allow the modular battery pack 1415 to accommodate a variety number and type of battery sub-units, which may be stacked to add depth or height to the modular battery pack 1415. The modular battery pack 1415 includes its own positive and negative terminals, which are connected to a manual service disconnect 1456 and a pair of external electrical connectors 1458 that are connected to a load (not shown). The electrical connectors 1458 (e.g., power and/or data connections) interface the modular battery pack 1415 with an electrical system powered by the modular battery pack 1415. The modular battery pack 1415 further includes a low voltage connector 1457 to provide data input/output functionality to the modular battery pack 1415. The modular battery pack 1415 still further includes electronic components to monitor and control the thermal and electrical performance of the modular battery pack 1415 (also referred to herein as a battery management system (BMS)). These electronic components also communicate with external control systems to control the continuity of the high-voltage applied by the modular battery pack 1415.

The battery sub-units are fluidly connected at their input/output ports. The modular battery pack 1415 includes pack input/output ports 1419 that allow the modular battery pack 1415 to connect to an external coolant supply and return. As discussed above with reference to the input/output ports for each of the battery sub-units, the pack input/output ports 1419 may also include rotatable fittings to change an orifice size, which in turn affects the rate of coolant flow into/out of the corresponding input/output port for the modular battery pack 1415. This feature may be used to balance flow rates through the coolant passages to aid in balancing temperature across multiple modular battery packs (and their associated battery sub-units). These rotatable fittings may function as integral valves on one or both input and the output.

Logical operations making up embodiments of the invention described herein may be referred to variously as operations, steps, objects, or modules. Furthermore, the logical operations may be performed in any order, adding or omitting operations as desired, regardless of whether operations are labeled or identified as optional unless explicitly claimed otherwise or a specific order is inherently necessitated by the claim language. Several implementations of the described technology have been described. Nevertheless, various modifications can be made without departing from the spirit and scope of the recited claims.

What is claimed is:

1. A battery sub-unit for a modular battery pack comprising:
a thermal plate with a first row of battery modules arranged in thermally conductive contact with a first thermally conductive surface of the thermal plate, the thermal plate forming a structural backbone for the battery sub-unit, wherein the thermal plate includes:
one or more internal coolant passages to flow coolant therethrough and conduct thermal energy from the battery modules though the thermal plate and into the coolant.

2. The battery sub-unit of claim 1, wherein the thermal plate further includes:
a first pair of mounting channels extending lengthwise down the thermal plate on opposing sides of the first thermally conductive surface of the thermal plate, the first row of battery modules structurally attached to the first pair of mounting channels thereby holding the first row of battery modules in compressive thermally conductive contact with the first thermally conductive surface of the thermal plate.

3. The battery sub-unit of claim 2, wherein a second row of battery modules are arranged in thermally conductive contact with a second thermally conductive surface of the thermal plate, the second thermally conductive surface opposing the first thermally conductive surface of the thermal plate, and wherein the thermal plate further includes:
a second pair of mounting channels extending lengthwise down the thermal plate on opposing sides of the second thermally conductive surface of the thermal plate, the second row of battery modules structurally attached to the second pair of mounting channels thereby holding the second row of battery modules in compressive thermally conductive contact with the second thermally conductive surface of the thermal plate.

4. The battery sub-unit of claim 3, further comprising:
a third pair of mounting channels extending lengthwise down the thermal plate on opposing sides of the second thermally conductive surface of the thermal plate, the third pair of mounting channels to selectively secure structural panels for the modular battery pack.

5. A battery module for a modular battery pack comprising:
a nested parallel array of cylindrical battery cells, positive and negative terminals of each located on one side of the nested parallel array;
a cell housing to mechanically secure the cylindrical battery cells in the nested parallel array;
a first collector plate overlying the positive and negative terminals of the cylindrical battery cells, the first collector plate wire bonded to a first subset of the positive and negative terminals of the cylindrical battery cells;
a second collector plate overlying the positive and negative terminals of the cylindrical battery cells, the second collector plate wire bonded to a second subset of the positive and negative terminals of the cylindrical battery cells; and
an isolator oriented between the positive and the negative collector plates to electrically separate the positive from the negative collector plates.

6. The battery module of claim 5, wherein one or both of the positive and the negative collector plates includes a flange oriented perpendicular to the collector plates that serves as a common terminal for the battery module.

7. The battery module of claim 5, wherein the first collector plate is a positive collector plate, the second collector plate is a negative collector plate, and the array of cylindrical battery cells are electrically connected in series or in parallel with the collector plates.

8. The battery module of claim 5, further comprising:
an array of thermistors protruding through the cell housing and extended between the cylindrical battery cells to monitor temperatures of the cylindrical battery cells.

9. The battery module of claim 5, further comprising:
additional collector plates overlying the positive and negative terminals of the cylindrical battery cells, the additional collector plates wire bonded to additional subsets of the positive and negative terminals of the cylindrical battery cells, wherein the array of cylindrical battery cells is electrically connected in series, in parallel, or a combination thereof with the collector plates.

10. The battery module of claim 9, wherein the first and the second collector plates and the additional collector plates are embedded within a common plane on a collector plate substrate that serves as the isolator.

11. The battery module of claim 9, wherein the first and the second collector plates and the additional collector plates are embedded within a common plane on a printed circuit board (PCB) that serves as the isolator.

12. The battery module of claim 11, wherein the PCB include a voltage tap connector and traces extending to the first and the second collector plates and the additional collector plates.

13. The battery module of claim 11, wherein the PCB monitors one or both of battery module voltages and temperatures.

14. A modular battery pack comprising:
a series of battery sub-units, each of the battery sub-units including:
a thermal plate forming a structural backbone for the battery sub-unit;
a first row of battery modules attached to the thermal plate and arranged in thermally conductive contact with a first thermally conductive surface of the thermal plate; and
a second row of battery modules attached to the thermal plate and arranged in thermally conductive contact with a second thermally conductive surface of the thermal plate opposing the first thermally conductive surface of the thermal plate, each of the battery modules including an array of cylindrical battery cells, positive and negative terminals of each at a first axial end of each of the cylindrical battery cells and thermal energy to conduct out of a second axial end of each of the cylindrical battery cells to the thermal plate, wherein the thermal plate further includes one or more internal coolant passages to flow coolant therethrough and conduct thermal energy from the battery modules though the thermal plate and into the coolant.

15. The modular battery pack of claim 14, further comprising:
a series of end cap manifolds, each attached to ends of the thermal plates.

16. The modular battery pack of claim 15, wherein the battery sub-units are arranged in parallel and aligned so that inputs to each of the series of end cap manifolds are axially aligned and outputs from each of the series of end cap manifolds are axially aligned.

17. The modular battery pack of claim 15, wherein a first set of linear tubing sections connect inputs to each of the series of end cap manifolds in line and a second set of linear tubing sections connect outputs to each of the series of end cap manifolds in line.

18. The modular battery pack of claim 15, wherein the end cap manifolds each include an integral valve on one or both of an input to a connected thermal plate and an output from the connected thermal plate.

19. The modular battery pack of claim 14, wherein a series of module bus bars electrically connect the battery modules within each of the battery sub-units and a series of sub-unit bus bars electrically connect the sub-units within the modular battery pack.

20. The modular battery pack of claim 14, wherein the battery modules are rotationally symmetric so that they are mountable in two directions on the thermal plate.
